(19) United States
(12) Patent Application Publication
(10) Pub. No.: US 2005/0227011 A1
(43) Pub. Date: Oct. 13, 2005

(54) Method and apparatus for applying fluids to a substrate

(75) Inventors: Hubert Kufner, Lueneburg (DE); Uwe Weddehage, Lueneburg (DE); Reinhard Meyer, Bleckede (DE)

Correspondence Address: WOOD, HERRON & EVANS, L.L.P., 2700 Carew Tower, 441 Vine St., Cincinnati, OH, 45202, US

(73) Assignee: Nordson Corporation

(21) Appl. No.: 10/946,627

(22) Filed: Sep. 21, 2004

(30) Foreign Application Priority Data
Sep. 22, 2003 (EP) 03021382.1

(51) Int. Cl. B05C 1/00

(52) U.S. Cl. 427/402; 427/428.06; 118/255

(57) ABSTRACT

The invention relates to a method and an apparatus for applying fluids, in particular adhesives, to a substrate (3), wherein a fluid is conveyed from a fluid source onto a circumferential surface (9) of an applicator roller (8) rotationally mounted by bearings onto a housing, and the circumferential surface (9) of the applicator roller (8) can be brought into contact with a substrate (3) in such a way that fluid is applied from the circumferential surface (9) of the applicator roller (8) onto the substrate (3). According to the invention, the fluid is conveyed from at least two different fluid sources to the circumferential surface (9) of the applicator roller (8) and subsequently transferred onto the substrate (3).

The present invention relates to a method and an apparatus for applying fluids, in particular adhesives, to a substrate, wherein a fluid is conveyed from a fluid source onto a circumferential surface of an applicator roller rotationally mounted by bearings onto a housing, and the circumferential surface of the applicator roller can be brought into contact with a substrate in such a way that fluid is applied from the circumferential surface of the applicator roller onto the substrate.

The invention further relates to dispensing apparatus for applying fluid, in particular adhesive, to a substrate, with an applicator roller rotationally mounted by bearings onto a housing, wherein fluid can be applied onto the circumferential surface of said roller from a fluid source, and wherein the circumferential surface of the applicator roller can be brought into contact with a substrate in such a way that fluid is applied from the circumferential surface of the applicator roller onto the substrate.

Such methods and dispensing apparatuses are used to apply free-flowing materials (referred to hereinafter as fluids) such as cold-setting adhesive, hot melt adhesive, sealants or the like onto different objects (referred to hereinafter as substrates). In the production of sanitary articles such as diapers or sanitary towels, for example, adhesives or sealants are applied to parts of said sanitary articles. Other examples include the application of adhesives to packaging, films, parts of furniture, spines of books, or the like.

A dispensing apparatus with a rotatable applicator roller is known from the published German patent application DE 100 54 425.8 by Nordson Corporation, in which a fluid passageway opening into the circumferential surface of said applicator roller is defined, said fluid passageway being filled with a fluid-permeable structure comprising a plurality of communicating cavities. The fluid-permeable structure may, for example, be a sintered metal member. By means of the fluid-permeable structure, for example in the form of a sintered metal member, it is possible to achieve a uniform distribution of the fluid as well as uniform application of the fluid onto the substrate.

There is a need in industry for methods and devices with which different fluids can be dispensed in a wide diversity of patterns. For example, there is a need to apply coatings with thin layer thicknesses, or to obtain special coatings or patterns.

The object of the present invention is therefore to provide improved application methods and dispensing apparatuses with which coatings of different shapes can be applied to a wide diversity of substrates. Another object of the invention is to enable particularly thin coatings with sharply defined edges, and any after dripping or trailing of fluid after application with an applicator roller is to be reduced as far as possible.

The invention achieves the object pursuant to a first aspect of the invention with a method of the kind initially specified, wherein fluid from at least two different fluid sources is conveyed to the circumferential surface of the applicator roller and subsequently transferred onto the substrate.

The invention further achieves the object pursuant to said aspect of the invention in an apparatus of the kind initially specified in that two separate feed channels connectable to different fluid sources are provided in the applicator roller, wherein fluid can be channeled through said channels to the circumferential surface of the applicator roller and transferred from thence onto the substrate.

Owing to the application of fluids from different fluid sources by means of an applicator roller in the manner according to the invention, different fluids, for example an adhesive layer and a sealant layer, can be advantageously applied to a substrate in a single step. Alternatively, it is also possible for fluids of different color to be applied simultaneously by means of the applicator roller. According to the invention, it is also possible for more than two fluids, for example three or four fluids, to be applied from different fluid sources by means of an applicator roller. For this purpose, a plurality of fluid passageways leading to the circumferential surface of the applicator roller would be defined in said applicator roller. In the case of sanitary products, in particular, it is desirable that adhesives or sealants be applied onto a product in a single sequence.

One particularly preferred embodiment is characterized in that the fluid is fed, prior to transfer onto the substrate, through a fluid-permeable structure comprising a plurality of communicating cavities that is provided in the fluid passageway of the roller. The fluid-permeable structure is appropriately in the form of a sintered metal member. This provides the special advantage that fluid is distributed very uniformly, in that the fluid is distributed while flowing through the intercommunicating cavities. Furthermore, a very thin layer of coating, indeed a coating that is partially interrupted, can be achieved with small amounts of coating per unit area. This is possible with the help of sintered metal members, especially. Sintered metal inserts disposed inside the fluid channels can also be used to advantage when applying several fluids from different fluid sources through several separate feed channels inside the applicator roller. In this way, uniform and sharply defined patterns with low “grammages” (i.e. low amounts of fluid mass per unit area) can be obtained.

Pursuant to a second aspect, the invention further achieves the object with a method of the kind previously specified in that at least two applicator rollers are arranged in tandem in the direction of movement of the substrate, such that the substrate is coated with fluid by the two successively arranged applicator rollers.

In an apparatus of the kind initially specified, this object is achieved pursuant to a second aspect of the invention in that two dispensing apparatuses with at least applicator rollers are arranged in tandem in the direction of movement of the substrate, such that the substrate is coated with fluid by the two applicator rollers arranged in tandem.

When applying adhesives or sealants, for example, onto substrates such as sanitary articles, different fluids can be applied successively according to the invention by means of applicator rollers arranged in tandem. The method is advantageously developed in such a way that different adjacent portions of the surface of the substrate are coated by the two or more applicator rollers. If adjacent portions are coated by the successively arranged applicator rollers, composite application patterns can be formed with no mixing of the fluids nor any transfer of fluid onto the respective other applicator roller. In this way, composite patterns can be produced.

According to an alternative embodiment of the method, it is proposed that equal portions of the substrate surface be successively coated with different fluids by the two or more applicator rollers. By applying different fluids by means of applicator rollers arranged in tandem—in the direction of substrate movement—, the fluids can be mixed on the substrate. This may be advantageous in the case of reactive adhesives or other substances, such that a chemical reaction occurs on the substrate after the adhesives have been mixed. By this means, it is also possible to deposit different fluids one above the other on a substrate.

This method is preferably executed in such a way that the first fluid applied by a first applicator roller hardens or dries at least partially, and subsequently an additional fluid is applied by means of a second applicator roller over the first fluid applied to the substrate, such that the effect of mixing, should this be undesirable for a particular application, is minimized as a result of the fluids hardening or drying.

According to a third aspect of the invention, the object is achieved with a method of the kind initially specified in that a fluid passageway filled with a fluid-permeable structure is provided in the applicator roller and opens with such a contoured edge into the surface of the applicator roller that a pattern with a curved edge is applied to the substrate.

The invention according to this latter aspect achieves the object equally in an apparatus of the kind initially specified in that the fluid-permeable structure extends as far as the circumferential surface of the applicator roller and takes the form of a separate sintered metal member attached to the applicator roller, and that the outer surface of the fluid-permeable structure is curved at its periphery in such a way that a pattern with a curved edge is produced on the substrate.

By means of a fluid-permeable sintered metal member that extends into the circumferential surface of the applicator roller and has contoured edges that are curved, not angular in shape, it is possible to obtain coating patterns with any kind of curved shape and which meet technical and/or esthetic requirements. Producing rounded, curved edges by means of applicator rollers fitted with sintered metal members is particularly advantageous, because it is also possible to obtain coatings that are uniform as far as the edges and have low grammages.

According to the invention, contiguous plane coatings or strip-like, circular, elliptical or differently shaped coatings can be produced.

According to a further aspect, the object is achieved according to the invention with a method for applying fluids in that the applicator roller is rotated at 350 to 600 revolutions per minute, preferably in a range around 500 revolutions per minute.

Rotational speeds in these ranges can be realized in the case of applicator rollers with fluid-permeable structures such as sintered metal members disposed in the fluid passageway, because the fluid in the cavities of the fluid-permeable structure is advantageously retained to a partial extent, rather than being thrown out of the passageway in an uncontrolled manner by the strong centrifugal forces that are present. Instead, reliable coating is achieved according to the invention even at such high rotational speeds and high substrate speeds. Such high rotational speeds enable the efficiency of production plant to be significantly increased.

Good coating results and, especially, adhesive application without unwanted threads or filaments of adhesive being formed at the point of contact between the applicator roller and the substrate, can be achieved in particular if the fluid is applied with a viscosity of between 1000 and 5000 cps (centipoise), preferably in the range from 1000 to 2000 cps and with a temperature of between 50 and 170° C., preferably in the range from 150 to 170° C.

According to a fifth aspect of the invention, the object is achieved with a method in which a gas stream, preferably an air stream, is channeled into the area of contact between the applicator roller and the substrate.

Such a gas stream ensures that stringing or thread formation during application of fluid, in particular adhesives, is reduced. With a high flow velocity of the gas stream, a kind of gas knife or air knife is realized with which the adhesive layer to be applied is separated from the applicator roller in order to break the bond to the applicator roller, avoid threads or filaments of fluid being pulled, and to support reliable transfer of the fluid onto the substrate. For this purpose, it is expedient to use air, and to channel the gas or air stream over the entire application width of the applicator roller into the area of contact between the applicator roller and the substrate.

Pursuant to this aspect of the invention, the associated dispensing apparatus is fitted with a gas nozzle through which a discrete film or layer of air that is substantially cylindrical or extends, particularly preferably, over the entire application width can be channeled into the area of contact.

A preferred embodiment of the invention provides that the volume or flow rate of the gas stream and/or the velocity of the gas stream is adjusted or regulated according to the speed of the substrate relative to the applicator roller. The gas stream can be automatically adjusted in this manner to the speed of the substrate, as can the circumferential speed of the applicator roller, such that fluid is transferred as favorably as possible in different operation states from the applicator roller onto the substrate.

Other advantageous embodiments of the method and dispensing apparatuses according to the invention are defined in the subclaims.

The invention shall now be described on the basis of preferred embodiments and with reference to the attached drawings. The drawings show:

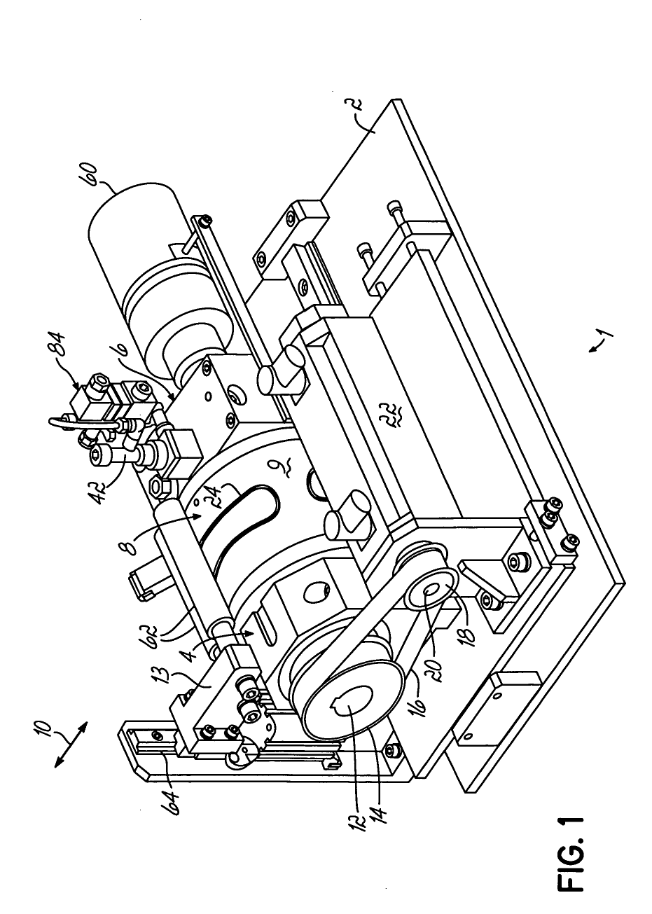

FIG. 1 a perspective view of an apparatus according to the invention for applying fluid;

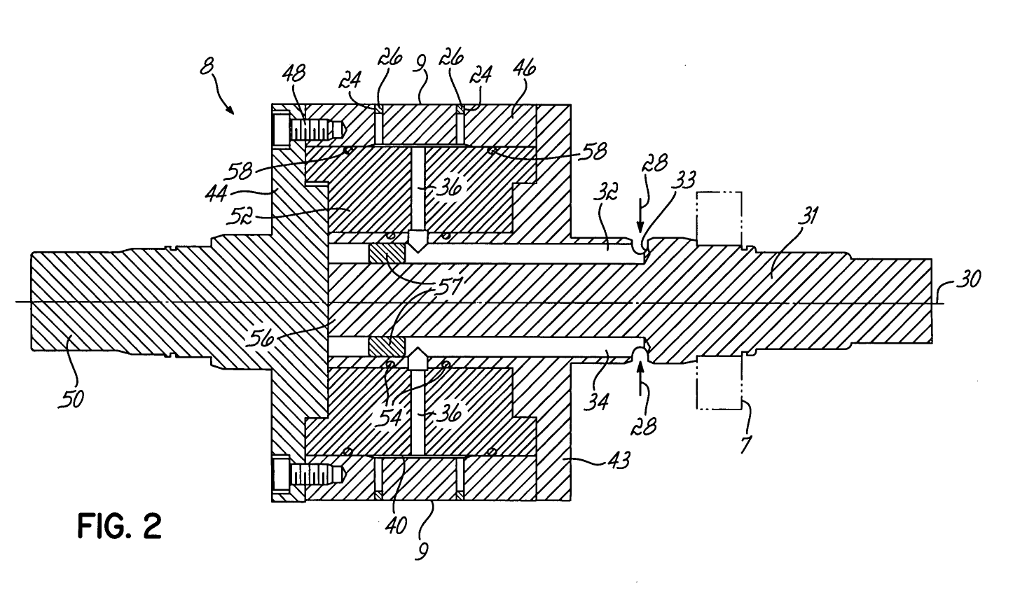

FIG. 2 an applicator roller of an apparatus pursuant to FIG. 1, in a cross-sectional view;

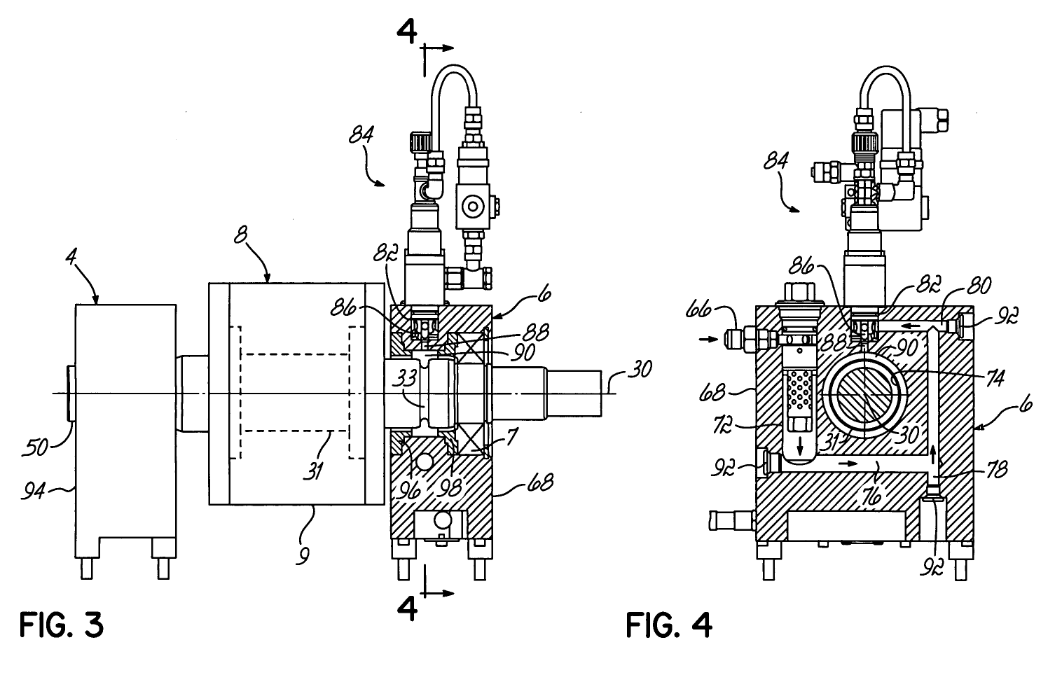

FIG. 3 a partial cross-section of an apparatus pursuant to FIG. 1;

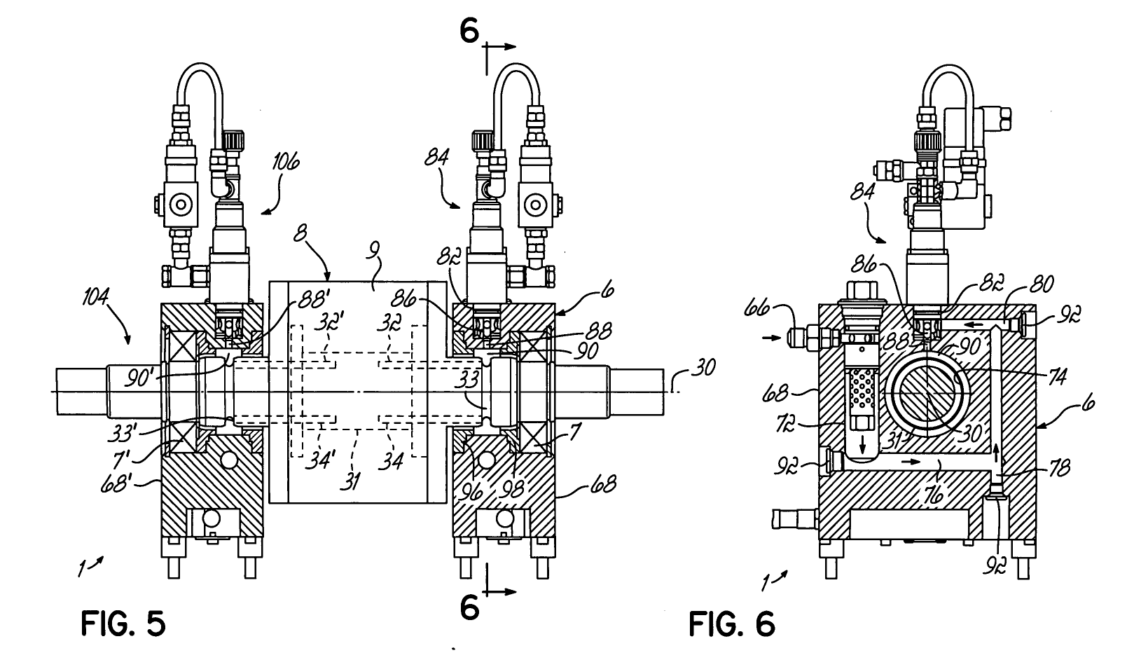

FIG. 4 a cross-sectional view along plane A-A in FIG. 3;

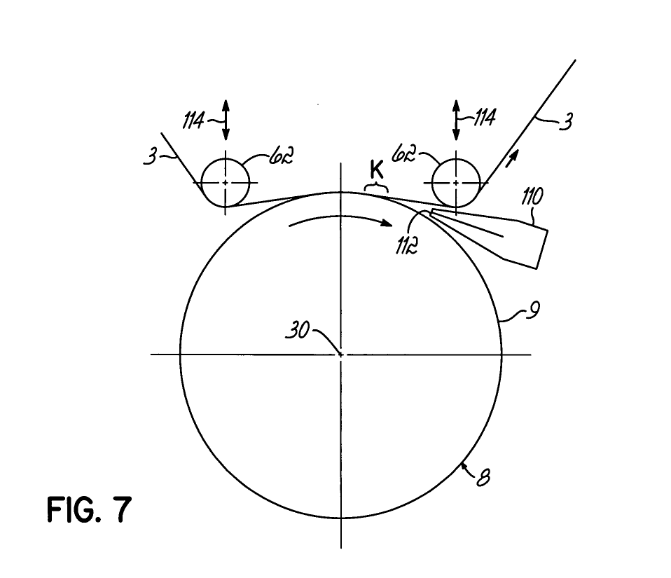

FIG. 5 an alternative embodiment in a partial cross-sectional view;

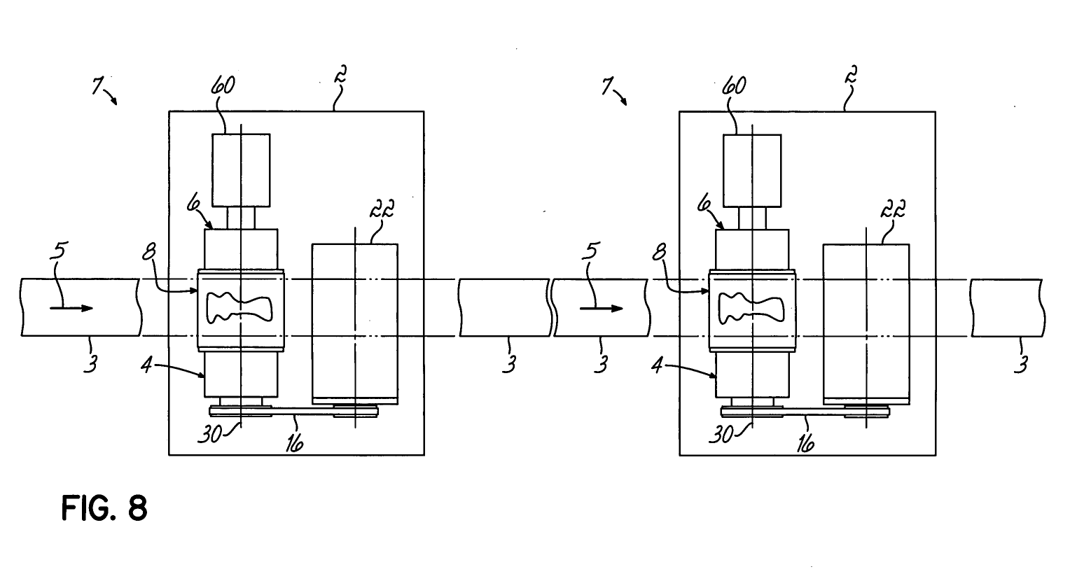

FIG. 6 the apparatus according to FIG. 5 in a cross-sectional view along plane A-A;

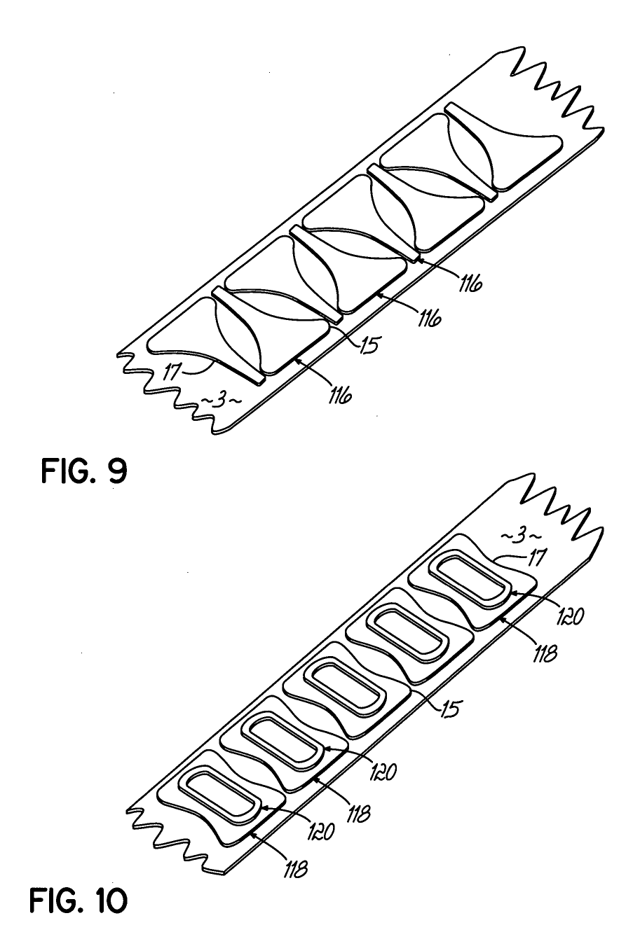

FIG. 7 a schematic view of part of an apparatus according to the invention, with a gas nozzle;

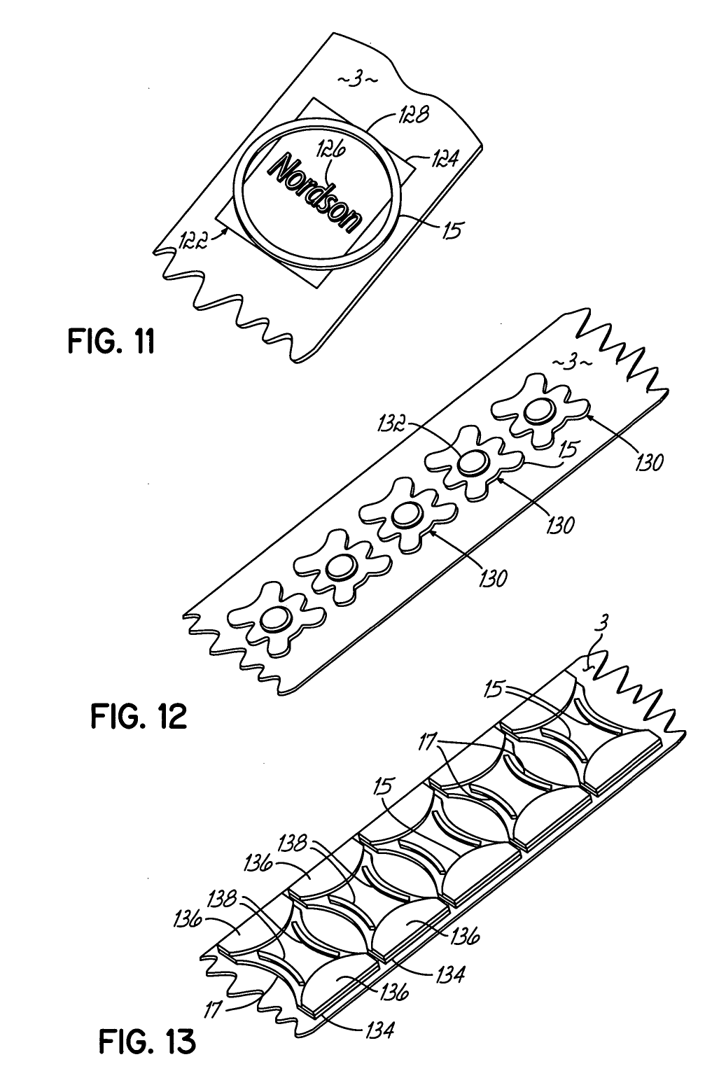

FIG. 8 a schematic plan view of two dispensing apparatuses disposed in sequence, with two applicator rollers in a plan view;

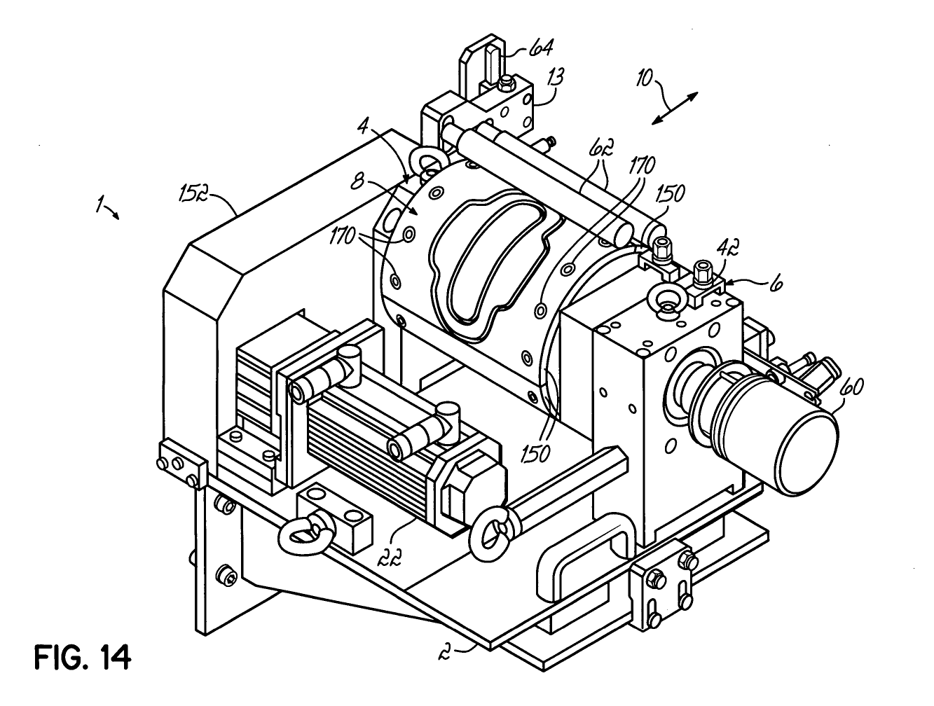

FIG. 9 a perspective plan view of a product coated using the method according to the invention, in an embodiment;

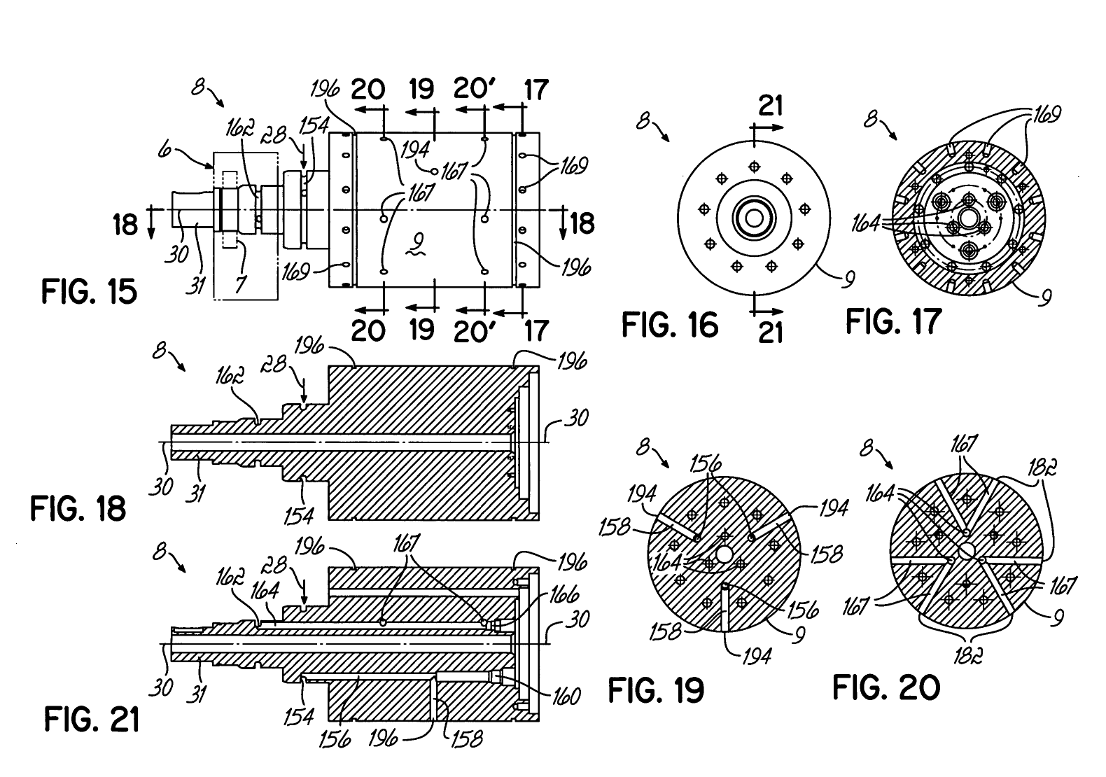

FIG. 10 a perspective plan view of a product coated using the method according to the invention, in a further embodiment;

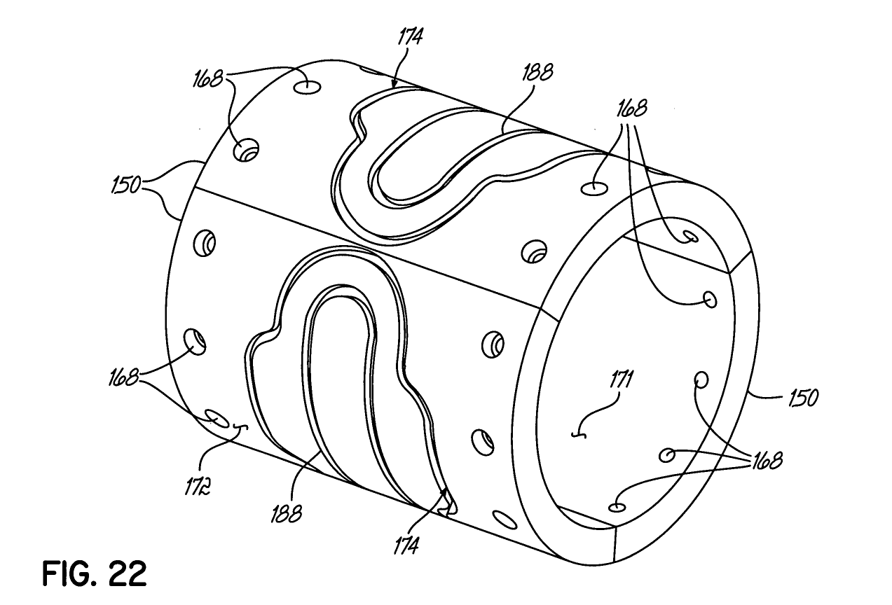

FIG. 11 a perspective plan view of a product coated using the method according to the invention, in a further embodiment;

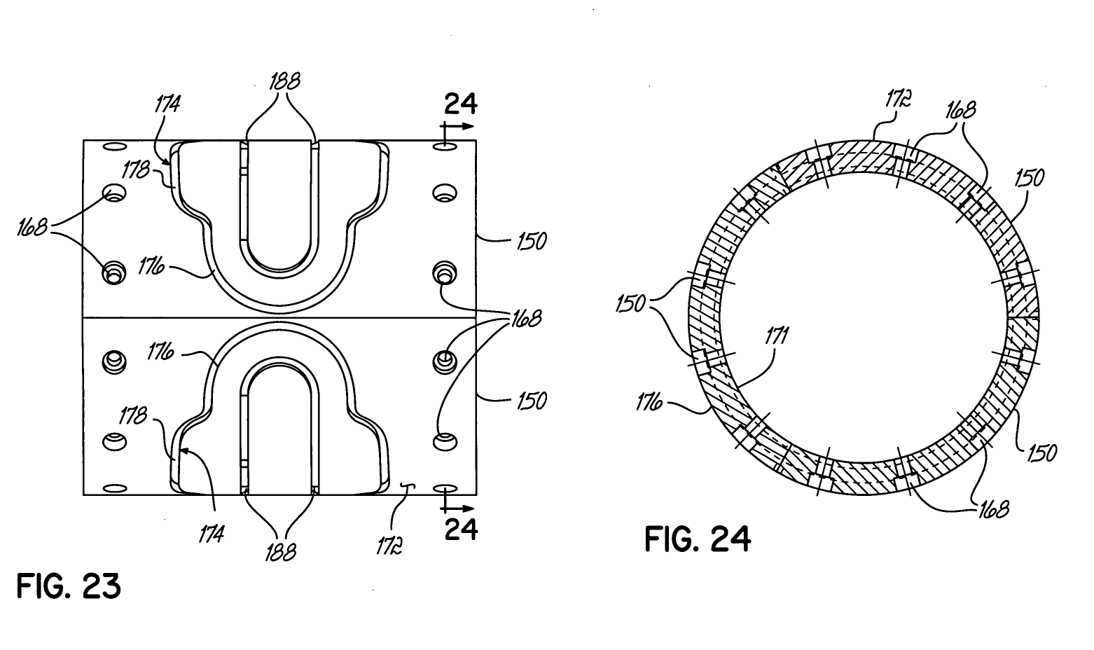

FIG. 12 a perspective plan view of a product coated using the method according to the invention, in a further embodiment;

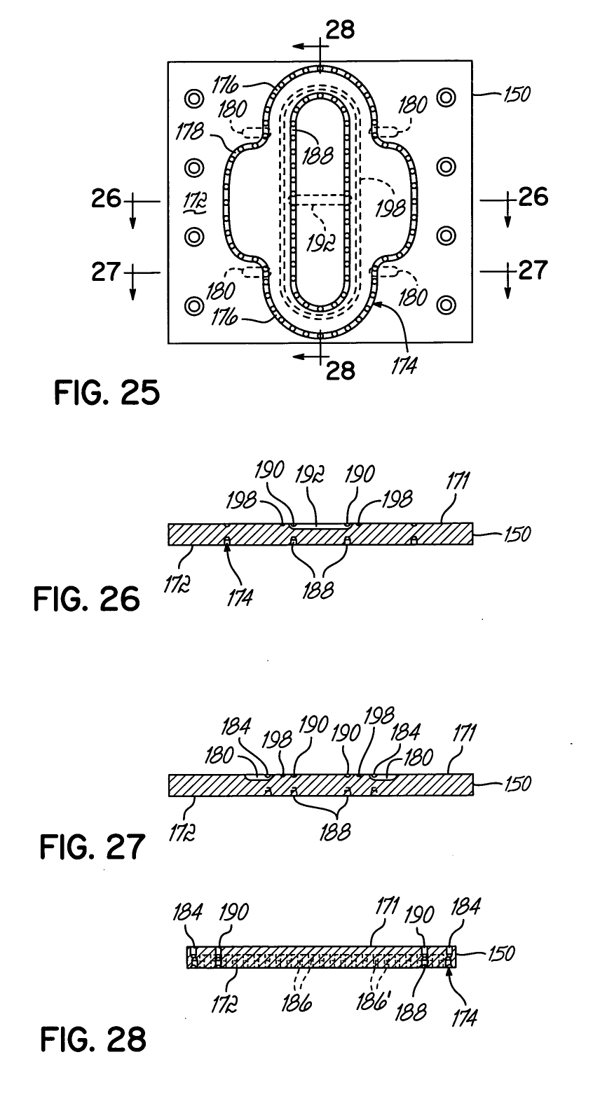

FIG. 13 a perspective plan view of a product coated using the method according to the invention, in a further embodiment.

The embodiment of a dispensing apparatus 1 shown in FIG. 1 serves to apply adhesive onto a sanitary article such as a diaper, but can also be used in a similar way for other purposes, for example to coat films, parts of packaging or parts of furniture with adhesives or sealants, or also to coat films with fluids of different colors. The component parts of the apparatus, described in the following in further detail, are supported by a base plate 2 that is attachable to a frame of a production plant.

Two spaced apart bearings or bearing blocks 4, 6 are mounted on the base plate 2 and serve, by means of a ball bearing 7 (see FIGS. 2 and 3) or sliding bearing in each to rotationally mount of bearings an applicator roller 8, the outer circumferential surface 9 of which comes into contact with a substrate for coating that is conveyed by means of a conveying means, not shown, along a path as indicated by the double-headed arrow 10 in FIG. 1. The base plate 2 and bearing blocks 4, 6 can be considered as a housing on which the applicator roller 8 is rotationally mounted on bearings.

In order to drive the applicator roller 8, an end portion 12 of the applicator roller 8 extends beyond the bearing block 4 and is coupled interlockingly to a gear wheel 14 that is connected to a toothed belt 16. The toothed belt 16 engages with a further gear wheel 18 which is coupled to a drive shaft 20 of a drive motor 22. The drive motor 22 screw-mounted onto the base plate 2 and is configured as an electric motor or, alternatively, as a fluid motor. By means of the drive motor 22, the applicator roller 8 can be driven at adjustable rotational speeds, depending on the specific application and the speed of the substrate. For example, rotational speeds of the applicator roller 8 of between 350 and 600 revolutions per minute, and circumferential speeds of up to 500 meters per minute can be achieved, and hence corresponding substrate speeds. The drive motor 22 is appropriately coupled to the substrate conveying means, not shown, or more precisely to its controller.

As is well shown in FIGS. 1 and 2, the applicator roller 8 comprises at least one fluid passageway 24 opening into the circumferential surface 9 of the applicator roller 8, said passageway being fed with fluid from a fluid source, not shown, for example from an adhesive reservoir, a melting vat or the like. Fluid is conveyed through the fluid passageway 24 into the area of the circumferential surface 9 and can be applied to the substrate through contact therewith. In the end portion of the fluid passageway 24, which opens into the circumferential surface 9, a fluid-permeable structure 26 is defined in the form of one or more sintered metal members that comprise a plurality of irregular, intercommunicating cavities through which the fluid can flow. The size of the cavities is adapted to the respective application, in particular to the properties of the fluid (viscosity) and the rotational speeds of the applicator roller 8. Sintered structures comprising metal balls ranging up to 0.1 mm in diameter may be used, for example. Other fluid-permeable structures with a plurality of intercommunicating cavities, for example porous rigid foam, can also be used instead of sintered metal members or inserts that can be fitted, pressed, bonded or otherwise attached inside the fluid passageway.

As shown by FIG. 2 in combination with FIG. 1, and as indicated by arrow 28, fluid is channeled in the area of the bearing block 6 through feed channels 32, 34 running parallel to the central and rotational axis 30 of the applicator roller 8 into the applicator roller 8, then flows through a plurality of radially disposed channels 36, 38 into a transverse distribution channel 40 in the form of a slit, and from thence into the fluid passageway 24 that opens into the circumferential surface 9. In the bearing block 6, a fluid from a fluid source or from several fluid sources can be channeled through a fluid infeed connector 42 and into the feed channels 32, 34. The feed channels 32, 34 are sealed at one end by plugs 57 that can be screwed or pressed into the channels.

The applicator roller 8 comprises a shaft 31, a first lateral limiting plate 42, an opposite second limiting plate 44 and a circumferential annular portion 46 enclosing the fluid passageways 24 and the sintered metal members, to which portion plate 44 is screw-mounted by means of screws 48. Plate 44 is integral with a shaft bearing portion 50. Channels 36 are disposed inside an additional, substantially annular roller element 52, which is sealed off with O-ring seals 54 from a shaft portion 56 and with O-rings 58 from the annular portion 46.

The applicator roller 8 can be electrically heated by means of a roller heater 60 (FIG. 1). Alternatively, in a manner not shown, the arrangement of the toothed belt 16 and the drive as a whole, as well as the roller heater 60 and the fluid infeed to the applicator roller 8 can, of course, be laterally reversed.

As FIG. 1 shows, the substrate conveyed past the roller can be guided and pressed against the roller in a desired position relative to the circumferential surface 9 of applicator roller 8, and at a desired angle of contact, by means of two feed rollers 62 rotationally mounted on bearings. By means of a linear guide 64 comprising a guide rail and roller bearings, not shown in the Figure, the guide rail 62 can be vertically adjusted and fixed in a desired position.

FIGS. 3 and 4 illustrate how fluid is fed through apparatus 1 into the applicator roller 8. A connecting piece 66 (FIG. 4) screwed into the bearing block 6 with ball bearing 7 is connectable to a fluid source and serves as a fluid infeed point. A filter element for filtering the fluid can be screwed into the housing 68 of bearing block 6 and is screwed into a vertical cylindrical bore 72 that communicates with a horizontal bore 76 disposed underneath a cylindrical bore 74 for receiving the applicator roller 8. Bore 76 is connected to a vertical bore 78 that is connected, for its part, to an additional horizontal bore 80, which in turn opens into a horizontal cylindrical bore 82. Screwed sealing plugs 92 close the ends of bores 76, 78 and 80.

A pneumatic control unit 84 that can be controlled by means of a control device (not shown) operates to release or interrupt the flow of fluid through the aforementioned bores 72, 76, 78, 80 and is coupled with a valve mechanism, in the form of a needle valve, that has a conventional valve needle 86 that is movable back and forth and which co-operates with a valve seat disposed in the lower portion of bore 82. Control unit 84 can be charged in a known manner by means of compressed air in order to move the valve needle 86 into the open or closed position.

As FIGS. 3 and 4 show, the valve seat is followed downstream by a bore 88 that opens into an annular passageway 90 that is disposed concentrically around the shaft 31 and is connected to a groove or bore 33 in shaft 31 (see also FIG. 2). Fluid flows through annular passageway 90 and bore 33 into feed channels 32, 34 (FIG. 2). Seals 96, 98 (FIG. 3) ensure that the annular passageway 90 is sealed, and may take the form of lip, gland or face seals. Inside the bearing block 4 shown on the left in FIG. 3, a ball bearing (not shown) for the shaft 31 is disposed inside the housing 94 of said block, and secured in the conventional manner.

The alternative embodiment, shown in FIGS. 5 and 6, of a dispensing apparatus device 1 serves to feed two fluids from different fluid sources into a single applicator roller 8. Some design features of said apparatus 1 are similar or identical to those in the embodiment previously described with reference to FIGS. 1 to 4; where the same or identical parts are present, the same numerals are also used, and reference is made to the description provided in the foregoing.

In the embodiment shown in FIGS. 5 and 6, the option of feeding fluid into the applicator roller 8 is provided not only in the bearing block 6, which was previously described with reference to FIGS. 3 and 4, but also in the opposite bearing block 104 (left-hand side in FIG. 5). For this purpose, a layout that is essentially the same as that at bearing block 6 is provided at bearing block 104, i.e. an additional control unit 106 is embedded in a housing 68′ at bearing 104. Fluid can flow through channel 88′ into an annular passageway 90′ and from thence into a groove or channel 33′ defined in shaft 31, and from thence into axial feed channels 32′, 34′ in shaft 31 (indicated with broken lines in FIG. 5), which have been described before with reference to FIG. 2. Through feed channels 32′ and 34′, fluid can flow through channels 36 (FIG. 2) (not shown in FIG. 5) and through fluid passageways 24 (FIG. 2) filled with sintered metal members into the area of the circumferential surface 9. In the same way, fluid flows through the fluid flow paths shown in the bearing block 6 (FIGS. 5 and 6) from a fluid source into the feed channels 32, 34 (FIG. 5) and from thence into fluid passageways 24 that communicate with said channels and open into the circumferential surface 9, as shown in FIG. 2. This means that different fluids, one from a first fluid source coupled to the bearing block 6 and a second fluid from a second fluid source coupled with bearing block 104, can be transported through the one applicator roller 8 into the circumferential surface 9 of applicator roller 8 and applied from there onto a substrate. Depending on the shape of the outlet openings of the fluid passageways 24, which are coupled with the different fluid sources, identical or different fluids can be applied onto the substrate in different shapes. The specific shapes of the patterns that can be produced are determined by the respective shape of the outlet openings of the feed channels 24 at the circumferential surface 9.

FIG. 7 shows in a schematic side elevation view a gas nozzle 110 pursuant to the invention for generating at least one gas stream, in particular an air stream, said gas nozzle being part of apparatus 1. In the embodiment shown, the gas nozzle 110 is configured as a slot nozzle with an elongated outlet opening 112 extending over the entire application width of the applicator roller 8, such that an air film or a layer of air can flow between the circumferential surface 9 and the substrate 3 into the area of contact K. Due to the escaping gas stream, the fluid applied by the applicator roller 8 is advantageously separated from the circumferential surface 9, and any stringing or unwanted sticking to the circumferential surface 9 is reduced or prevented. The gas nozzle 110 can also be referred to as an air knife, with the help of which the fluid is in a sense cut away from the applicator roller 8 in the area of contact K.

The gas nozzle 110 is attached, in a manner not shown, to a support structure for the dispensing apparatus 1 or to a support structure 13 underneath the guide or feed roller 62, shown in FIG. 1. The support structure 13 serves to hold and bed two feed rollers 62 or guide rollers 62 shown in FIG. 7 so that the substrate 3 is guided in a defined manner along a defined path in the area of the applicator roller 8. As FIG. 7 suggests, the guide rollers 62 can be vertically adjusted (arrow 114 in FIG. 7) by means of a linear guide 64. Alternatively, the guide rollers 62 may also be pivotably disposed so that they can be pivoted away from the applicator roller 8.

FIG. 8 shows an embodiment of an apparatus and method according to the invention for applying fluid, in which two successively arranged fluid application apparatuses 1 are provided in order to be able to coat a substrate 3, shown schematically, by means of two applicator rollers 8. The two dispensing apparatuses 1 are arranged in tandem, may be configured like the embodiment shown in FIGS. 1 and 2 or 5 and 6, and be arranged in tandem in the direction in which the substrate 3 moves, as illustrated by arrows 5 in FIG. 3, such that the substrate 3 is initially guided to applicator roller 8 of the first dispensing apparatus, on the left in FIG. 8, and subsequently to the next applicator roller 8 of the second dispensing apparatus 1, on the right in FIG. 8, and coated with different or identical fluids. Reference is made to the foregoing descriptions with regard to the design of dispensing apparatus 1.

Coated substrates 3 made in accordance with the invention are shown by way of example in FIGS. 9 to 13. It can be seen that the edges of the patterns or pictures produced on the substrates 4 are mainly non-angular in shape, but instead have curved, rounded contours or edges 15 with different radii of curvature. The edges 15 can, at least in part, be circularly convex or curved concavely, and/or shaped elliptically, parabolically or the like. The curved portions of edges 15 can transition into straight portions. It is also possible for different fluids to be applied in successive layers on the substrate, one upon the other. This is achieved if the outer periphery of the fluid-permeable structure 26 of applicator roller 8, in particular the sintered metal members at the circumferential surface 9, is appropriately curved, as can be seen from the examples in FIG. 1 and FIG. 8. If the design of structure 26 is adapted to the specific case and the desired application pattern according to FIGS. 9 to 13, patterns with curved contours or edges, or at least edge portions, can be produced.

FIG. 9 shows a plane substrate 3—for example a plastic film for the production of sanitary articles (e.g. diapers), a paper strip or the like—with a plane contiguous coating 115 applied in accordance with the invention, with convexly curved and rounded edges 15 and curved, concavely rounded edge portions 17. The separate areas of coating 116 are applied adjacent to each other by means of the applicator roller 8. A method involving only one applicator roller 8, or a method with two applicator rollers 8 in tandem, as shown in FIG. 8, can be used, wherein each second coating 116 in the latter case can be applied by one applicator roller 8 and the respective adjacent coatings 116 by the other applicator roller. The coating can be an adhesive, a sealant, plastic or gel padding, or the like. Thus, coatings with defined edges or contours can be produced, preferably with contours that are curved and rounded at will, but also with more angular contours if so required.

FIG. 10 illustrates a substrate with several contiguous plane coatings 118. Coatings 118 are firstly applied to the substrate, before additional coatings 120—shown in the embodiment as continuous annular coatings in the form of strips or chains of beads—are applied, for example as sealing. The patterns thus created are preferably produced by means of two dispensing apparatuses 1 arranged in tandem (FIG. 8), wherein the first apparatus 1 applies the plane coating 118 and the second dispensing apparatus 1 applies the additional coating 120 on top of the first coating 118. The strip-like coating 120 has similarly curved and rounded edges. To achieve this, the respective applicator roller 8 is configured with a corresponding shaped fluid passageway 24 with an insert comprising a fluid-permeable structure 26, preferably a sintered metal member. If necessary, the first coating 118 can firstly be dried or partially dried, for example with an air stream or infrared radiator or the like, which can be placed between the two apparatuses 1 arranged in tandem and shown in FIG. 8.

FIG. 11 illustrates a substrate 3 bearing a coating 122 in the form of a corporate logo, comprising at least one contiguous, in this case parallelepipedal coating 124, and a company name 126 made up of letters, and an additional ring element 128. The contiguous coating 124 can firstly be applied by a first applicator roller 8, then the coating 126 comprised of letters is applied by a second applicator roller in a manner according to the invention, before the ring-shaped coating 128 is applied according to the invention by a third downstream apparatus 1.

In FIG. 12, a substrate 3 is coated with two superimposed graphic coatings 130 with curved edge contours 15, on top of which a further, substantially circular coating 132 comprised of a different fluid is applied. In this case also, it is preferable to use a method and an arrangement 2 of apparatuses 1 with applicator rollers 8, said apparatuses being disposed in tandem one after the other in the direction of substrate movement.

Finally, FIG. 13 shows a substrate 3 with a first lower plane coating 134 with convexly curved edge portions 15 and additional plane coatings 136 applied at the two outer edge areas of coating 134. In the middle portion of coating 134, two coatings 138 in the form of strips or chains of beads are applied in a manner according to the invention.

In addition to the above descriptions, the methods according to the invention will now be described with reference to the Figures:

Fluid is fed into the apparatus from a fluid source (not shown) through connection piece 66 (FIGS. 4 and 6) in the area of the bearing block 6, and then flows when the valve is open (i.e. when the valve needle 86 is in the open position) through filter 70, and bores 72, 76, 78, 80, 82 and 88 into the annular passageway 90 (FIGS. 3 and 5). When an apparatus with two fluid supply lines as shown in FIG. 5 is used, fluid also flows at bearing block 104 into annular passageway 90′ in the manner just described. From thence, the fluid flows through feed channels 32, 34 and 32′, 34′ into the applicator roller 8 and from thence into the fluid passageways 24 (FIG. 2), which are filled with a fluid-permeable structure, preferably with sintered metals.

As FIG. 7 shows, a substrate 3 is conveyed by means of rollers 62 past the circumferential surface 9 of applicator roller 8 in such a way that the fluid is transferred onto the substrate 3, thus coating said substrate. Very high substrate speeds, in the range previously described, can be achieved thereby. The fluid-permeable structure is very advantageous in that, despite high circumferential speeds and hence strong centrifugal forces, the fluid is not thrown off the applicator roller 8 in an uncontrolled manner.

An air stream produced by the gas nozzle 110 (FIG. 7) and directed at the areas of contract K acts favorably on the transfer of fluid onto the substrate 3. Pursuant to the invention, the gas stream from the gas nozzle 110 is preferably adjusted according to the speed of the substrate and/or the rotational speed of the applicator roller 8. The higher the speed, the more intense the gas stream, i.e. the greater are the flow rate and the gas velocity.

When an apparatus pursuant to FIGS. 5 and 6 is used, different fluids can be applied simultaneously by means of an applicator roller 8 from two fluid sources connected to said applicator roller 8.

In an arrangement pursuant to FIG. 8, comprising two apparatuses 1 in tandem, fluid can be transferred successively onto a substrate. To do this, either one apparatus pursuant to FIG. 3 is used, in which fluid is supplied from one fluid source, and/or an apparatus pursuant to FIG. 5 is used, in which fluid is supplied from two or more fluid sources arranged in tandem.

According to the invention, the patterns and coatings shown by way of example in FIGS. 8-11 can be produced, as can any coatings of whatever deviating design. Depending on the specific application, different free-flowing materials (fluids) can be applied to the substrate in a manner according to the invention in order to make very different products. To reduce stringing during application, fluids with low cohesiveness can be used, for example.

1-47. (canceled)

48. A method for dispensing first and second fluids onto a substrate, comprising:
directing the first and second fluids onto a circumferential surface of a first applicator roller from respective first and second fluid sources,
contacting the circumferential surface of the first applicator roller with the substrate, and
rotating the first applicator roller to apply the first and second fluids from the circumferential surface onto the substrate.

49. The method according to claim 48, further comprising:
feeding the first and second fluids from the first and second fluid sources to respective first and second feed passages communicating with the circumferential surface of the first applicator roller.

50. The method according to claim 48, further comprising:
feeding the first fluid through a fluid-permeable structure comprising a plurality of cavities communicating with one another and further communicating with the circumferential surface of the first applicator roller.

51. The method according to claim 48, further comprising:
moving the substrate in a machine direction,
arranging a second applicator roller downstream of the first application roller in the machine direction, and
coating the substrate with the first and second fluids by the first applicator roller and with additional fluid from the second applicator roller.

52. The method according to claim 51, further comprising:
coating first and second adjacent portions of the substrate, respectively, with the first and second applicator rollers.

53. The method according to claim 52, further comprising:
coating equal portions of the substrate successively with the fluids applied by the first and second applicator rollers.

54. The method according to claim 51, further comprising:
applying the first and second fluids onto the substrate one on top the other by the respective first and second applicator rollers.

55. The method according to claim 54, further comprising:
at least partially hardening the first fluid, and subsequently applying the second fluid on top of the first fluid.

56. The method according to claim 48, further comprising:
directing at least one of the first and second fluids through a fluid passageway in the applicator roller, the fluid passageway being filled with a fluid-permeable structure and having a contoured edge opening into the circumferential surface of the applicator roller, and
applying a at least one of the first and second fluids to the substrate in a pattern having a curved edge.

57. The method according to claim 48, further comprising:
applying the first and second fluids in the form continuous areal coatings having rounded edges.

58. The method according to claim 48, further comprising:
applying the first and second fluids in the form of strips of beads.

59. The method according to claim 48, further comprising:
applying the first and second fluids in the form of an annular, closed bead.

60. The method according to claim 48, wherein the applicator is rotated at 350 RPM to 600 RPM.

61. The method according to claim 48, wherein the first and second fluids are applied with a viscosity in the region of 1000 cps to 5000 cps and with a temperature in the region of 50° C. to 170° C.

62. The method according to claim 48, further comprising:
directing a gas stream into a junction formed between the applicator roller and the substrate.

63. The method according to claim 63, further comprising:
moving the substrate while applying the fluid from the applicator roller, and adjusting at least one of the volume, flow rate and velocity of the gas stream according to the speed of the substrate relative to the applicator roller.

64. The method according to claim 63, further comprising:
increasing the speed of the moving substrate, and
increasing at least one of the flow rate and the velocity of the gas stream while increasing the speed of the substrate.

65. An apparatus for applying first and second fluids onto a substrate, comprising:
a housing, and
an applicator roller rotationally mounted to said housing, said applicator roller having a circumferential surface for applying the first and second fluids onto the substrate and first and second feed passages adapted to be connected to respective first and second sources of the first and second fluids and separately communicating with said circumferential surface to apply the first and second fluids to the substrate.

66. The apparatus according to claim 65, wherein said applicator roller rotates about an axis and said first and second feed passages extend parallel said axis.

67. The apparatus according to claim 66, further comprising:
a drive shaft coupled to said applicator roller, wherein said first and second feed passages extend within said drive shaft and are connected to passageways within said applicator roller, said passageways extending outwardly from the axis to the circumferential surface of the applicator roller.

68. The apparatus according to claim 65, further comprising:
a fluid-permeable structure comprising a plurality of cavities communicating with one another and further communicating with at least one of said first and second feed passages, said fluid permeable structure extending to and communicating with said circumferential surface of said applicator roller.

69. The apparatus according to claim 68, wherein said fluid permeable structure further comprises a sintered metal part.

70. The apparatus according to claim 69, wherein said sintered metal member further comprises an outer surface with a periphery which is curved to produce a pattern of at least one of the first and second fluids with a curved edge on the substrate.

71. The apparatus according to claim 70, wherein the periphery of the sintered metal member is rounded in shape.

72. The apparatus according to claim 65, further comprising:
a gas nozzle positioned for supplying a gas stream adjacent said applicator roller.

73. The apparatus according to claim 72, wherein said gas nozzle further comprises a nozzle structure extending substantially across an entire width of said applicator roller.

74. The apparatus according to claim 72, wherein said gas nozzle is positioned in such a way that the gas stream can be channeled into a contact area between said circumferential surface of said applicator roller and the substrate.

75. The apparatus according to claim 74, further comprising:
a control device operatively connected with said gas nozzle for adjusting the gas stream in accordance with at least one of a rotational speed of said applicator roller and a speed of movement of the substrate.

76. An apparatus for applying two or more fluids onto a substrate, comprising:
a housing, and
an applicator roller rotationally mounted to said housing, said applicator roller having a circumferential surface, a plurality of segments releasably fixed to the applicator roller in the region of said circumferential surface for applying the two or more fluids onto the substrate, and feed passages adapted to be connected to respective sources of the two or more fluids and separately communicating with said plurality of segments to apply the two or more fluids to the substrate.

77. The apparatus according to claim 76, wherein each segment in said plurality of segments has a continuous fluid passage therethrough communicating with one of said feed passages.

78. The apparatus according to claim 76, further comprising:
a fluid-permeable structure comprising a plurality of cavities communicating with one another and further communicating with at least one of said feed passages, said fluid permeable structure extending to and communicating with said circumferential surface of said applicator roller.

79. The apparatus according to claim 68, wherein said fluid permeable structure further comprises a sintered metal member.

80. The apparatus according to claim 76, wherein each segment in said plurality of segments is releasably fixed to the applicator roller by a screw connection.
